(19) United States
(12) Patent Application Publication
(10) Pub. No.: US 2026/0269596 A1
(43) Pub. Date: Sep. 10, 2026

(54) SHUT-OFF CONTROL DEVICE

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-shi, Osaka (JP)

(72) Inventor: Takafumi KAWAKAMI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/873,282

(22) PCT Filed: Jun. 15, 2022
(86) PCT No.: PCT/JP2022/023943

§ 371 Date: Dec. 9, 2024

(51) Int. Cl. H02H 3/087; B60R 16/03

(52) U.S. Cl. CPC H02H 3/087; B60R 16/03

(57) ABSTRACT

A shut-off control device in an in-vehicle system includes a power source unit, a power path, a switch, and a shut-off unit. The power path is a path through which power is transmitted between the power source unit and a load. The switch is provided on the power path and switches the power path between a current-carrying state and a current-interrupting state. The shut-off unit is switched from an allowing state in which the shut-off unit allows power to be supplied from the power source unit to the load through the power path to a shut-off state in which the shut-off unit shuts off power supplied from the power source unit to the load. The shut-off control device includes a control unit that switches the shut-off unit to the shut-off state when a value of a current flowing through the power path has exceeded a first threshold.

### CROSS-REFERENCE TO RELATED APPLICATIONS

This application is the U.S. national stage of PCT/JP2022/023943 filed on Jun. 15, 2022, the contents of which are incorporated herein.

### TECHNICAL FIELD

The present disclosure relates to a shut-off control device.

### BACKGROUND

In the background art of JP 2015-35951A, a load circuit that supplies power to a load is disclosed. This load circuit includes a battery and a switch (semiconductor switch) provided between the battery and the load, and the switch is turned on or off to drive or stop the load.

There is a risk that the above-described switch may fail to operate normally when a current larger than a threshold flows through the switch. When the switch is configured to be capable of withstanding a larger current, the switch tends to become large.

The present disclosure has an object of providing a technology that can prevent a switch from failing to operate normally while suppressing an increase in the size of the switch.

### SUMMARY

A shut-off control device according to the present disclosure is used in an in-vehicle system including: a power source unit; a power path through which power is transmitted between the power source unit and a load; a switch provided on the power path and configured to switch the power path between a current-carrying state and a current-interrupting state; and a shut-off unit configured to be switched from an allowing state to a shut-off state, the shut-off unit in the allowing state allowing power to be supplied from the power source unit to the load through the power path, and the shut-off unit in the shut-off state shutting off power supplied from the power source unit to the load, the shut-off control device including a control unit configured to switch the shut-off unit to the shut-off state when a value of a current flowing through the power path has exceeded a first threshold, wherein the first threshold is smaller than a second threshold that is the maximum current value at which the switch is capable of maintaining the power path in the current-carrying state.

### Advantageous Effects

The technology according to the present disclosure can prevent the switch from failing to operate normally while suppressing an increase in the size of the switch.

### BRIEF DESCRIPTION OF DRAWINGS

FIG. 1 is a configuration diagram schematically showing an example of an in-vehicle system including a shut-off control device according to a first embodiment.

FIG. 2 is a graph of correspondence data showing a correspondence between a time elapsed from the occurrence of a ground fault and the value of a current flowing through a power path.

### DETAILED DESCRIPTION OF PREFERRED EMBODIMENTS

The following lists example embodiments of the present disclosure.

In a first aspect, a shut-off control device used in an in-vehicle system including: a power source unit; a power path through which power is transmitted between the power source unit and a load; a switch provided on the power path and configured to switch the power path between a current-carrying state and a current-interrupting state; and a shut-off unit configured to be switched from an allowing state to a shut-off state, the shut-off unit in the allowing state allowing power to be supplied from the power source unit to the load through the power path, and the shut-off unit in the shut-off state shutting off power supplied from the power source unit to the load, the shut-off control device including a control unit configured to switch the shut-off unit to the shut-off state when a value of a current flowing through the power path has exceeded a first threshold, wherein the first threshold is smaller than a second threshold that is the maximum current value at which the switch is capable of maintaining the power path in the current-carrying state.

In the shut-off control device, the control unit switches the shut-off unit to the shut-off state when the value of a current flowing through the power path has exceeded the first threshold. The first threshold is set to a value smaller than the second threshold that is the maximum current value at which the switch can maintain the power path in the current-carrying state. Therefore, the control unit is likely to switch the shut-off unit to the shut-off state before the switch fails to maintain the power path in the current-carrying state. Accordingly, even if the second threshold becomes small as a result of an increase in the size of the switch being suppressed, a current larger than the second threshold is unlikely to flow through the switch, and consequently a situation in which the switch fails to maintain the power path in the current-carrying state is likely to be avoided. Therefore, with this configuration, it is possible to prevent the switch from failing to operate normally while suppressing an increase in the size of the switch.

In a second aspect, the shut-off control device according to the first aspect, wherein the switch is an electromagnetic relay the power path enters the current-carrying state when the switch is switched on and enters the current-interrupting state when the switch is switched off, and when a current larger than the second threshold flows through the switch, the switch is switched from on to off by electromagnetic repelling force.

According to this configuration, the control unit is likely to switch the shut-off unit to the shut-off state before the switch is switched from on to off by the electromagnetic repelling force.

In a third aspect, the shut-off control device according to the first or the second aspects, wherein the second threshold is smaller than a saturation current that flows through the power path when a ground fault occurs in the power path.

This configuration makes it possible to use, in the in-vehicle system, a switch for which the maximum current value at which the switch can maintain the current-carrying state is smaller than the saturation current to suppress an increase in the size of the switch. Moreover, in this configuration, it is possible to prevent the switch from failing to operate normally.

In a fourth aspect, the shut-off control device according to the third aspect, wherein the first threshold is set such that the shut-off unit is switched to the shut-off state before the value of the current flowing through the power path reaches the saturation current, in view of a time lag from when it is determined that the value of the current flowing through the power path has exceeded the first threshold to when the shut-off unit is switched to the shut-off state.

With this configuration, it is possible to switch the shut-off unit to the shut-off state before the value of the current flowing through the power path reaches the saturation current.

In a fifth aspect, the shut-off control device according to any one of the first through the fourth aspects, wherein the first threshold is set such that the shut-off unit is switched to the shut-off state before the value of the current flowing through the power path reaches the second threshold, in view of a time lag from when it is determined that the value of the current flowing through the power path has exceeded the first threshold to when the shut-off unit is switched to the shut-off state.

With this configuration, it is possible to switch the shut-off unit to the shut-off state before the value of the current flowing through the power path reaches the second threshold. Accordingly it is possible to avoid a situation in which a current larger than the second threshold flows through the switch and the switch fails to maintain the power path in the current-carrying state.

In a sixth aspect, the shut-off control device according to any one of the first through the fifth aspects, wherein the first threshold is larger than a third threshold that is the maximum value of a current that may flow through the power path when the power path is in a normal state.

With this configuration, a situation in which the shut-off unit is switched to the shut-off state in the normal state of the power path is likely to be avoided.

In a seventh aspect, the shut-off control device according to any one of the first through the sixth aspects, wherein any of a pyrofuse, a semiconductor switch, and an electromagnetic fuse is used as the shut-off unit.

With this configuration, the shut-off unit is likely to rapidly switch to the shut-off state.

### First Embodiment

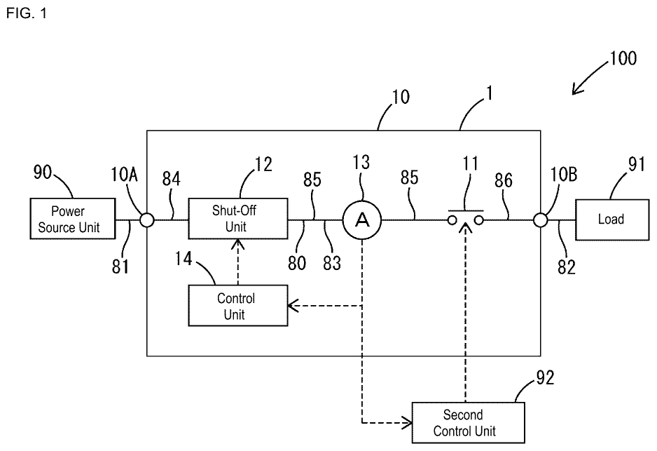

An in-vehicle system 100 shown in FIG. 1 is a system installed in a vehicle. The in-vehicle system 100 includes a power source unit 90, a load 91, a power path 80, a shut-off control device 1, and a second control unit 92.

The power source unit 90 is a DC power source that produces a DC voltage, for example, and is a battery, for example. Examples of the battery include a lead battery and a lithium ion battery. The load 91 is an electronic component included in the vehicle. Examples of the load 91 include an electric component, an ECU, and an ADAS component. The power path 80 is a path through which power is transmitted between the power source unit 90 and the load 91. One end of the power path 80 is electrically connected to the power source unit 90 and another end of the power path 80 is electrically connected to the load 91.

The shut-off control device 1 is used in the in-vehicle system 100. The shut-off control device 1 is configured as a junction box, for example. The shut-off control device 1 includes a housing 10, a switch 11, a shut-off unit 12, a current detecting unit 13, and a control unit 14. The switch 11, the shut-off unit 12, the current detecting unit 13, and the control unit 14 are disposed inside the housing 10. The housing 10 includes a first terminal portion 10A and a second terminal portion 10B.

The above-described power path 80 includes a first wiring portion 81, a second wiring portion 82, and a conductive path 83. The first wiring portion 81 and the second wiring portion 82 are disposed outside the housing 10, and the conductive path 83 is disposed inside the housing 10.

The first wiring portion 81 is configured as an electric wire, for example. One end of the first wiring portion 81 is electrically connected to the power source unit 90 and another end of the first wiring portion 81 is electrically connected to the first terminal portion 10A. The second wiring portion 82 is configured as an electric wire, for example. One end of the second wiring portion 82 is electrically connected to the second terminal portion 10B and another end of the second wiring portion 82 is electrically connected to the load 91.

The conductive path 83 is configured as a bus bar, for example. One end of the conductive path 83 is electrically connected to the first terminal portion 10A and another end of the conductive path 83 is electrically connected to the second terminal portion 10B. The conductive path 83 includes a first conductive path 84, a second conductive path 85, and a third conductive path 86. One end of the first conductive path 84 is electrically connected to the first terminal portion 10A and another end of the first conductive path 84 is electrically connected to one end of the shut-off unit 12. One end of the second conductive path 85 is electrically connected to another end of the shut-off unit 12 and another end of the second conductive path 85 is electrically connected to one end of the switch 11. One end of the third conductive path 86 is electrically connected to another end of the switch 11 and another end of the third conductive path 86 is electrically connected to the second terminal portion 10B.

The switch 11 is configured as an electromagnetic relay, for example, and includes contacts that operate under electromagnetic force. The switch 11 is provided on the power path 80 (more specifically the conductive path 83) and switches the power path 80 between a current-carrying state and a current-interrupting state. The switch 11 is provided between the second conductive path 85 and the third conductive path 86 and switches the section between the second conductive path 85 and the third conductive path 86 between a conductive state and a non-conductive state. When the section between the second conductive path 85 and the third conductive path 86 is in the conductive state, the power path 80 is in the current-carrying state. When the section between the second conductive path 85 and the third conductive path 86 is in the non-conductive state, the power path 80 is in the current-interrupting state. When the switch 11 is switched on, the section between the second conductive path 85 and the third conductive path 86 enters the conductive state and the power path 80 enters the current-carrying state. When the switch 11 is switched off, the section between the second conductive path 85 and the third conductive path 86 enters the non-conductive state and the power path 80 enters the current-interrupting state. The switch 11 is controlled by the second control unit 92.

The shut-off unit 12 is configured as a pyrofuse (registered trademark), a semiconductor switch, an electromagnetic fuse, or the like, for example. The shut-off unit 12 is provided on the power path 80 (more specifically, the conductive path 83). The shut-off unit 12 is closer to the power source unit 90 than the switch 11 is on the power path 80 (more specifically the conductive path 83). The shut-off unit 12 is switched from an allowing state in which the shut-off unit 12 allows power to be supplied from the power source unit 90 to the load 91 through the power path 80 to a shut-off state in which the shut-off unit 12 shuts off power supplied from the power source unit 90 to the load 91. The shut-off unit 12 is provided between the first conductive path 84 and the second conductive path 85. The shut-off unit 12 is switched from the allowing state in which the shut-off unit 12 allows power to be supplied from the first conductive path 84 to the second conductive path 85 to the shut-off state in which the shut-off unit 12 shuts off power supplied from the first conductive path 84 to the second conductive path 85. In the case where the shut-off unit 12 is a pyrofuse (registered trademark), a semiconductor switch, or an electromagnetic fuse, the shut-off unit 12 is likely to rapidly switch to the shut-off state. The shut-off unit 12 may be configured to be capable of returning to the allowing state after once entering the shut-off state, or not capable of returning to the allowing state after entering the shut-off state. The shut-off unit 12 is controlled by the control unit 14.

The current detecting unit 13 is configured as a known current sensor, for example. The current detecting unit 13 detects a current flowing through the power path 80 (more specifically the second conductive path 85). The current detecting unit 13 outputs a signal from which a detected value can be identified. This signal is input to the control unit 14 and the second control unit 92.

The control unit 14 controls the shut-off unit 12. The control unit 14 is configured as a micro controller unit (MCU), for example. The control unit 14 is configured as a device separate from the second control unit 92. The control unit 14 identifies the value of a current flowing through the power path 80 based on a signal output from the current detecting unit 13. The control unit 14 switches the shut-off unit 12 to the shut-off state when the value of the current flowing through the power path 80 has exceeded a first threshold Ith1.

The second control unit 92 controls the switch 11. The second control unit 92 is configured as a micro controller unit (MCU), for example. The second control unit 92 is disposed outside the housing 10. When a start condition determined in advance is satisfied, the second control unit 92 controls the switch 11 to switch the power path 80 to the current-carrying state. Specifically, the second control unit 92 switches on the switch 11. The start condition is satisfied when an ignition switch of the vehicle is turned on, for example. When a stop condition determined in advance is satisfied, the second control unit 92 controls the switch 11 to switch the power path 80 to the current-interrupting state. Specifically the second control unit 92 switches off the switch 11. The stop condition is satisfied when the ignition switch of the vehicle is turned off, for example. When a shut-off condition determined in advance is satisfied, the second control unit 92 controls the switch 11 to switch the power path 80 to the current-interrupting state. Specifically the second control unit 92 switches off the switch 11. The shut-off condition is a condition that may be satisfied based on the value of a current flowing through the power path 80, for example. The condition that may be satisfied based on the value of a current flowing through the power path 80 is, for example, a condition that the value of the current flowing through the power path 80 is larger than a reference value. The second control unit 92 identifies the value of the current flowing through the power path 80 based on a signal output from the current detecting unit 13.

Depending on the capacity of the switch 11, there is a risk that the switch 11 may fail to maintain the current-carrying state due to an increase in the value of the current flowing through the power path 80 before the switch 11 is switched off by the second control unit 92 as a result of the shut-off condition being satisfied. Therefore, the above-described first threshold Ith1 is set to a value smaller than a second threshold Ith2 that is the maximum current value at which the switch 11 can maintain the power path 80 in the current-carrying state. Accordingly the control unit 14 is likely to switch the shut-off unit 12 to the shut-off state before the switch 11 fails to maintain the power path 80 in the current-carrying state. Therefore, even if the second threshold becomes small as a result of an increase in the size of the switch 11 being suppressed, a current larger than the second threshold Ith2 is unlikely to flow through the switch 11, and consequently a situation in which the switch 11 fails to maintain the power path 80 in the current-carrying state is likely to be avoided. Therefore, with this configuration, it is possible to prevent the switch 11 from failing to operate normally while suppressing an increase in the size of the switch 11.

The switch 11 is an electromagnetic relay. When a current flowing through the power path 80 flows into the electromagnetic relay, electromagnetic repelling force is generated in the electromagnetic relay in such a manner as to change the electromagnetic relay from the on-state to the off-state. This electromagnetic repelling force increases as the current flowing into the electromagnetic relay increases. When the current flowing into the electromagnetic relay exceeds the above-described second threshold Ith2, the electromagnetic repelling force becomes larger than a force that maintains the electromagnetic relay in the on-state, and the electromagnetic relay changes to the off-state. In the state where the electromagnetic relay has changed to the off-state, there is a risk that an arc may be generated in the electromagnetic relay and the electromagnetic relay may break down. However, the above-described first threshold Ith1 is set to a value smaller than the second threshold Ith2 as described above. Therefore, the control unit 14 is likely to switch the shut-off unit 12 to the shut-off state before the switch 11 is switched from on to off by the electromagnetic repelling force.

The second threshold Ith2 is set to a value smaller than a saturation current IS that flows through the power path 80 when a ground fault occurs in the power path 80. The saturation current IS is, for example, a saturation current of a case where it is assumed that a ground fault occurs at the second terminal portion 10B in a state where the power source unit 90 is fully charged and the in-vehicle system 100 has not deteriorated.

This configuration makes it possible to use, in the in-vehicle system 100, a switch 11 for which the maximum current value at which the switch 11 can maintain the current-carrying state is smaller than the saturation current IS to suppress an increase in the size of the switch 11. Moreover, in this configuration, it is possible to prevent the switch 11 from failing to operate normally.

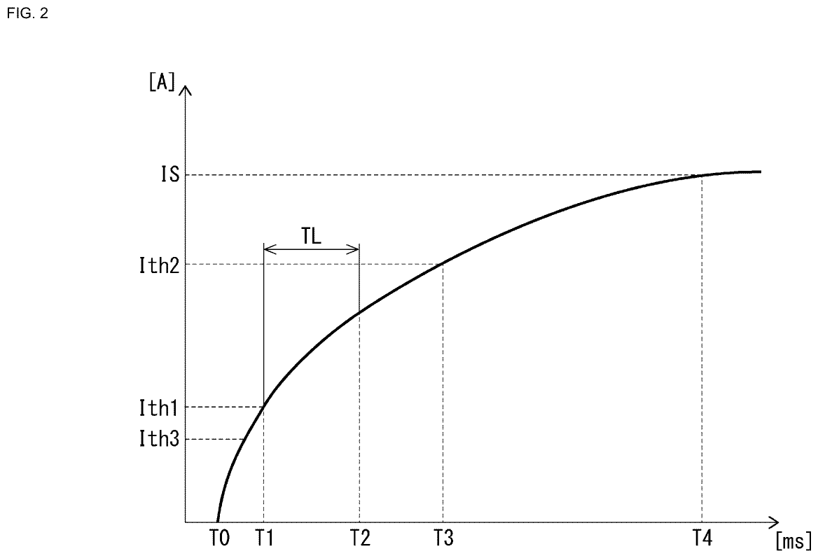

The first threshold Ith1 is set such that the shut-off unit 12 is switched to the shut-off state before the value of the current flowing through the power path 80 reaches the saturation current IS, in view of a time lag TL from when it is determined that the value of the current flowing through the power path 80 has exceeded the first threshold Ith1 to when the shut-off unit 12 is switched to the shut-off state. For example, the first threshold Ith1 is set based on the time lag TL and correspondence data (see FIG. 2) indicating a correspondence between a time elapsed from the occurrence of a ground fault and the value of a current flowing through the power path 80.

The time lag TL occurs due to the time it takes for the control unit 14 to start control for switching the shut-off unit 12 to the shut-off state upon determining that the current value has exceeded the first threshold Ith1 and the time it takes for the shut-off unit 12 to switch to the shut-off state after the control for switching the shut-off unit 12 to the shut-off state is started. The time lag TL is obtained from a test result or a simulation result, for example.

The correspondence data is obtained from a test result or a simulation result, for example. The test result or the simulation result is a result obtained by causing a ground fault at the second terminal portion 10B in a state where the power source unit 90 is fully charged and the in-vehicle system 100 has not deteriorated, for example.

In the correspondence data shown in FIG. 2, a ground fault occurs at a timing TO. Thereafter, the value of the current gradually increases with the passage of time. The value of the current flowing through the power path 80 reaches the saturation current IS at a timing T4.

It is possible to determine that the value of the current flowing through the power path 80 has reached the saturation current IS when the time elapsed from the occurrence of the ground fault is three times a time constant τ or when 1 ms has elapsed from the occurrence of the ground fault. The time constant τ is calculated using the following formula (1), for example.

$$Time constant τ = ( L 1 + L 2 + L 3 ) / ( R 1 + R 2 + R 3 ) \qquad Formula ( 1 )$$

L1 is an internal inductance of the power source unit 90. L2 is an inductance of the path between the power source unit 90 and the second terminal portion 10B. L3 is an inductance at the position at which the ground fault occurs. R1 is an internal resistance value of the power source unit 90. R2 is a resistance value of the path between the power source unit 90 and the second terminal portion 10B. R3 is a resistance value at the position at which the ground fault occurs. Note that L3 and R3 may vary depending on how the ground fault occurs, and therefore, may be set to 0, for example.

For example, a current value corresponding to a timing T1 that avoids a situation in which the elapsed time reaches the timing T4 even when the time lag TL is taken into account is set as the first threshold Ith1. That is to say a timing T1 for which a timing T2 after the time lag TL has elapsed therefrom is earlier than the timing T4 is identified, and a current value corresponding to the timing T1 is set as the first threshold Ith1.

With this configuration, it is possible to switch the shut-off unit 12 to the shut-off state before the value of the current flowing through the power path 80 reaches the saturation current IS.

The first threshold Ith1 is set such that the shut-off unit 12 is switched to the shut-off state before the value of the current flowing through the power path 80 reaches the second threshold Ith2, in view of the time lag TL from when it is determined that the value of the current flowing through the power path 80 has exceeded the first threshold Ith1 to when the shut-off unit 12 is switched to the shut-off state. The first threshold Ith1 is set based on the time lag TL and the above-described correspondence data, for example.

In the correspondence data shown in FIG. 2, the value of the current flowing through the power path 80 reaches the second threshold Ith2 at a timing T3. For example, the current value corresponding to the timing T1 that avoids a situation in which the elapsed time reaches the timing T3 even when the time lag TL is taken into account is set as the first threshold Ith1. That is to say, the timing T1 for which the timing T2 after the time lag TL has elapsed therefrom is earlier than the timing T3 is identified, and the current value corresponding to the timing T1 is set as the first threshold Ith1.

With this configuration, it is possible to switch the shut-off unit 12 to the shut-off state before the value of the current flowing through the power path 80 reaches the second threshold Ith2. Accordingly it is possible to avoid a situation in which a current larger than the second threshold Ith2 flows through the switch 11 and the switch 11 fails to maintain the power path 80 in the current-carrying state.

The first threshold Ith1 is set to a value larger than a third threshold Ith3 that is the maximum value of a current that may flow through the power path 80 when the power path 80 is in a normal state. The normal state of the power path 80 is a state in which a ground fault has not occurred in the power path 80, or more specifically, a state in which the voltage value of the power path 80 is higher than or equal to a threshold voltage. The threshold voltage is 0 V or higher. The maximum value of the current that may flow through the power path 80 is the value of a current that flows through the power path 80 when the load 91, such as a motor, in the vehicle is operated to its maximum in the state where the power source unit 90 is fully charged, for example.

With this configuration, a situation in which the shut-off unit 12 is switched to the shut-off state in the normal state of the power path 80 is likely to be avoided.

### Other Embodiment

The present disclosure is not limited to the embodiment described above with reference to the drawings. For example, features of the above embodiment or the following embodiment may be combined suitably as long as no contradiction arises. Also, any feature of the above embodiment or the following embodiment may be omitted unless the feature is described as essential. Furthermore, the above embodiment may be modified as described below.

In the above embodiment, the second control unit 92 is disposed outside the shut-off control device 1, but the second control unit 92 may also be disposed inside the shut-off control device 1. That is to say, the second control unit 92 may also be included in the shut-off control device 1.

Note that the disclosed embodiments are examples in all aspects and should not be construed to be limiting the present disclosure. The scope of the present disclosure is not limited to the embodiments disclosed herein, and is intended to encompass all modifications within the scope of the claims and a scope that is equivalent to the claims.

1. A shut-off control device used in an in-vehicle system including:
a power source unit;
a power path through which power is transmitted between the power source unit and a load;
a switch provided on the power path and configured to switch the power path between a current-carrying state and a current-interrupting state; and
a shut-off unit configured to be switched from an allowing state to a shut-off state, the shut-off unit in the allowing state allowing power to be supplied from the power source unit to the load through the power path, and the shut-off unit in the shut-off state shutting off power supplied from the power source unit to the load,
the shut-off control device comprising a control unit configured to switch the shut-off unit to the shut-off state when a value of a current flowing through the power path has exceeded a first threshold,
wherein the first threshold is smaller than a second threshold that is the maximum current value at which the switch is capable of maintaining the power path in the current-carrying state.

2. The shut-off control device according to claim 1,
wherein the switch is an electromagnetic relay, the power path enters the current-carrying state when the switch is switched on and enters the current-interrupting state when the switch is switched off, and when a current larger than the second threshold flows through the switch, the switch is switched from on to off by electromagnetic repelling force.

3. The shut-off control device according to claim 1,
wherein the second threshold is smaller than a saturation current that flows through the power path when a ground fault occurs in the power path.

4. The shut-off control device according to claim 3,
wherein the first threshold is set such that the shut-off unit is switched to the shut-off state before the value of the current flowing through the power path reaches the saturation current, in view of a time lag from when it is determined that the value of the current flowing through the power path has exceeded the first threshold to when the shut-off unit is switched to the shut-off state.

5. The shut-off control device according to claim 4,
wherein the first threshold is set such that the shut-off unit is switched to the shut-off state before the value of the current flowing through the power path reaches the second threshold, in view of the time lag from when it is determined that the value of the current flowing through the power path has exceeded the first threshold to when the shut-off unit is switched to the shut-off state.

6. The shut-off control device according to claim 5,
wherein the first threshold is larger than a third threshold that is the maximum value of a current that may flow through the power path when the power path is in a normal state.

7. The shut-off control device according to claim 6,
wherein any of a pyrofuse, a semiconductor switch, and an electromagnetic fuse is used as the shut-off unit.

8. The shut-off control device according to claim 1,
wherein the first threshold is set such that the shut-off unit is switched to the shut-off state before the value of the current flowing through the power path reaches the second threshold, in view of a time lag from when it is determined that the value of the current flowing through the power path has exceeded the first threshold to when the shut-off unit is switched to the shut-off state.

9. The shut-off control device according to claim 1,
wherein the first threshold is larger than a third threshold that is the maximum value of a current that may flow through the power path when the power path is in a normal state.

10. The shut-off control device according to claim 2,
wherein the second threshold is smaller than a saturation current that flows through the power path when a ground fault occurs in the power path.

11. The shut-off control device according to claim 2,
wherein the first threshold is set such that the shut-off unit is switched to the shut-off state before the value of the current flowing through the power path reaches the second threshold, in view of a time lag from when it is determined that the value of the current flowing through the power path has exceeded the first threshold to when the shut-off unit is switched to the shut-off state.

12. The shut-off control device according to claim 2,
wherein the first threshold is larger than a third threshold that is the maximum value of a current that may flow through the power path when the power path is in a normal state.
